(19) United States
(12) Patent Application Publication
(10) Pub. No.: US 2011/0221934 A1
(43) Pub. Date: Sep. 15, 2011

(54) Ground-Based Instrumentation Operating with Airborne Wave Reflectors

(75) Inventors: David E. Simon, Alexandria, VA (US); Paul S. Patricio, Centreville, VA (US)

(73) Assignee: Ideal Innovations Incorporated, Arlington, VA (US)

(21) Appl. No.: 12/722,930

(22) Filed: Mar. 12, 2010

(51) Int. Cl. H04N 5/238; H04N 5/262

(52) U.S. Cl. 348/240.3; 348/369; 348/E05.04; 348/E05.055

(57) ABSTRACT

An imaging system incorporates an elevated reflector mounted on a tall ground structure or a means for air flight to reflect a target area onto an imaging device, thus projecting the line-of-sight of said imaging device and enabling the imaging device to view target areas that are beyond the imaging device's direct line-of-sight.

### BACKGROUND OF THE INVENTION

This invention generally relates to remote sensing equipment. Specifically, it relates to an imaging system for conducting indirect Line-of-Site (“LOS”) long distance surveillance.

With the ongoing conflicts in Iraq and Afghanistan, the role of remote sensing equipment is more critical than ever. In general, sensing elements are either ground-based which restricts their effective Field-of-View (“FOV”) in many cases, or airborne, which presents a host of difficulties including the ability of the airborne craft to carry the sensing elements, the duration over which the sensing elements can remain aloft, the availability of the power required to operate these sensing elements on an aerial platform, and difficulties associated with transmitting the sensed signals back to a remote operator.

Accordingly, several objects and advantages of the invention are:

(a) to provide a sensor construction using multiple disparate elements including sensing elements and reflecting elements;

(b) to provide a sensor construction that can be deployed with an elevated reflector and a ground based sensor;

(c) to provide a sensor construction that can increase the FOV of a ground based sensor without elevating the sensor itself.

### SUMMARY OF THE INVENTION

Illustrative embodiments provide an imaging system wherein an elevated reflector is used to reflect the FOV of a ground-based imaging device onto a remote location. This may be accomplished by tall ground structure or a means for air flight to reflect a target area to an imaging device. By focusing on the elevated reflector, the ground-based imager's FOV is reflected onto a different target location which may be elsewhere on the ground. This presents the user with a clear view of the target.

### BRIEF DESCRIPTION OF THE DRAWINGS

FIG. 1 shows a conventional observation configuration with a tower-mounted imaging device.

FIG. 2 shows a different conventional observation configuration with an imaging device mounted on an aircraft.

FIG. 3 shows an exemplary configuration of a ground-based imaging device receiving the reflected FOV of a remote location from a dirigible mounted elevated reflector.

FIG. 4 shows an exemplary configuration of a ground-based imaging device receiving the reflected FOV of a remote location where the elevated reflector is integrated into the exterior surface of an aircraft.

FIG. 5 shows an exemplary configuration of a ground-based imaging device receiving the reflected FOV of a remote location where the elevated reflector is connected to a dirigible by a flexible mount that is adjustable by a motorized actuator.

FIG. 6 shows an exemplary configuration of a ground-based imaging device receiving the reflected FOV of a remote location where the elevated reflector is connected to the top of a tower.

FIG. 7 shows an exemplary configuration of a ground-based imaging device receiving the reflected FOV of a remote location where the elevated reflector is connected to a dirigible, which is connected by a tether to a ground base.

### DETAILED DESCRIPTION

This detailed description of exemplary embodiments of the invention makes reference to the drawings, which show the exemplary embodiments as well as conventional sensory imaging configurations. While these exemplary embodiments are described in sufficient detail to enable those skilled in the art to practice the invention, it should be understood that other embodiments may be realized and that logical and mechanical changes may be made without departing from the scope of the invention. Thus, the following detailed description is presented for purpose of illustration only and not by way of limitation.

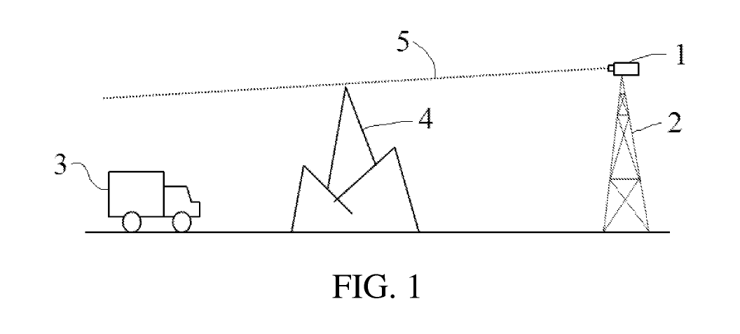

Referring now to FIG. 1, there is an example of a conventional system. In this example, imaging device 1 is mounted on a tower 2. The desired surveillance target 3 is behind an obstruction 4 (a mountain). Thus, the target remains hidden from the imager's direct LOS 5. This illustrates a problem of conventional systems: towers have limited height, and in regions with many large obstacles such as other building and mountains, the LOS and effective viewing distance of tower-mounted devices can be limited.

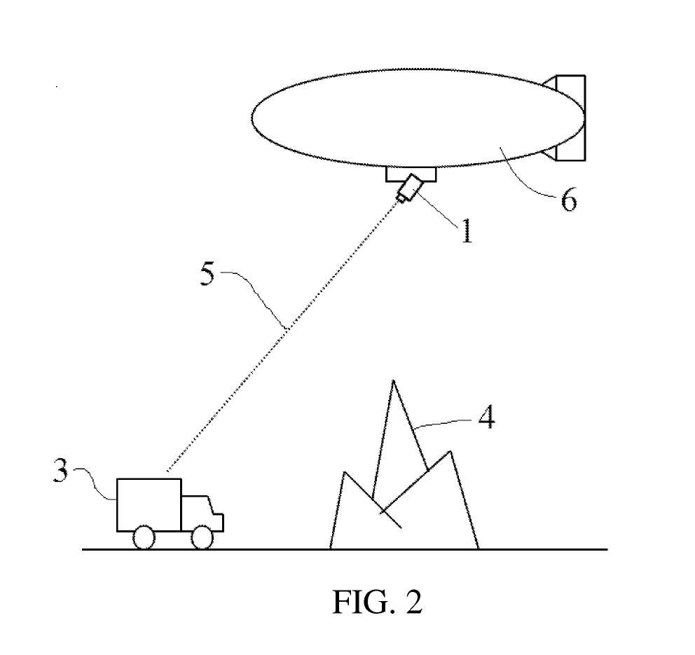

Referring now to FIG. 2, there is another example of a conventional system. In this example, a means for air flight 6 is shown as a dirigible carrying an imaging device 1. The target 3 is now in the imaging device's direct LOS 5, no longer blocked by the obstruction 4. However, this illustrates another problem of conventional systems: The imaging payload and associated power and data transmission gear must be carried aloft. The disadvantage of this approach is the large amounts of additional weight that must be carried by the air flight means.

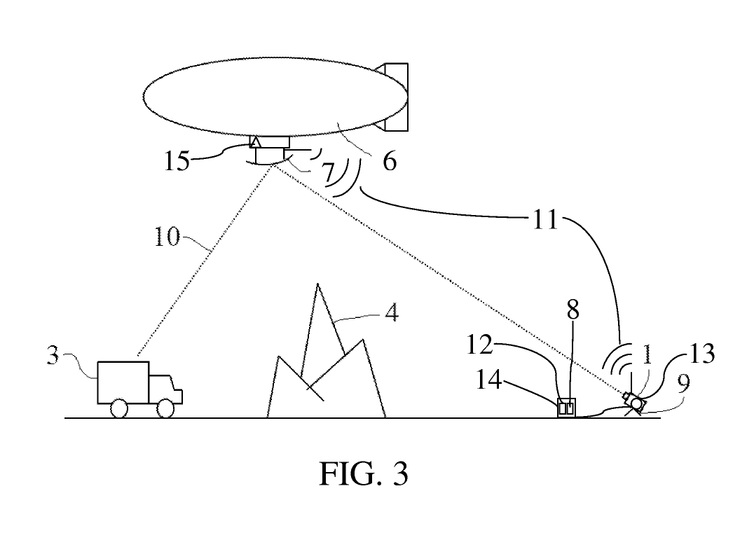

Referring now to FIG. 3, there is illustrated the preferred embodiment of the invention. Air flight means 6 is equipped with at least one elevated reflector 7. Imaging device 1 is shown mounted near the ground on flexible mount 9, but the reflected view of the target is still in the indirect LOS 10 of the imager. Electrical network 11 is shown connecting an imaging device 1 connected to a flexible mount and motorized actuator, a means for air flight 6, at least one elevated reflector 7 connected to the air flight means, a computer 14 communicatively associated with the imaging device, a means for deconvolving images 12 implemented on the computer, a means for position identification 15 of the elevated reflector, and a means for controlling the position of the imaging device 8 implemented on the computer.

In this embodiment the imaging device 1 detects optical images; however detecting non-visible electromagnetic radiation is contemplated as well. The imaging device can take the form of digital and non-digital cameras, both still image and video. These cameras can range from commercially available models to specialized reconnaissance devices with high-powered, zoom lenses and equivalent devices that will be recognized by one of ordinary skill in the art.

Imaging device 1 is connected to a flexible mount 9. The flexible mount allows the imaging device to turn up to 360° in the horizontal direction and 180° in the vertical direction enabling the imaging device to react to changes in the location of the elevated reflector. The flexible mount can be operatively associated with a motorized actuator 13 that, in conjunction with the position information communicated by the electrical network 11 and a means for controlling the position of said imaging device 8 implemented on computer 14, will automatically adjust the imaging device such that the LOS is continuously trained on the elevated reflector 7. Such control systems will be readily recognized by those of ordinary skill in the art.

The elevated reflector 7 is a specularly reflective surface such as a mirror that reflects electromagnetic radiation. The reflector can be made out of polished aluminum, tin, silver, glass, or other similar materials with reflective properties. Such equivalent materials will be readily recognized by those of ordinary skill in the art. Additionally, flexible specular materials such as biaxially-oriented polyethylene terephthalate films (“boPET films”) of which Mylar® is an example, can be used. In the preferred embodiment the elevated reflector's geometry is that of a hemisphere; however smaller portions of a sphere, ellipsoids or portions of ellipsoids, or other shapes are also possible. The shape of the elevated reflector can be flat, concave, or convex with respect to the incident rays of the target, depending on the desired optical properties. If the elevated reflector is flat, then there is no distortion, which would have the advantage of less wave processing and direct viewing. If the elevated reflector is convex, then a wider field of view would be projected allowing for areas of surveillance. In the concave configuration, the elevated reflector would give a smaller field of view, but would have the advantage of greater intensity so imaging device would be able to obtain useful information from farther distances. The reflector could also be designed to change its shape through one of several methods recognized by one of ordinary skill in the art. These methods include but are not limited to those incorporating: multiple individual reflecting elements; a flexible outer skin supported by an adjustable frame; or shape memory alloys (SMAs) or other shape-changing materials.

In the preferred embodiment, the electrical network 11 is configured such that information indicating the position of the elevated reflector 7 may pass from the elevated reflector to a computer 14 communicatively associated with the imaging device 1. A means for position identification 15 of the elevated reflector such as a global positioning system (“GPS”) device can be used to determine the position of the elevated reflector. In this configuration a GPS device is attached to the elevated reflector so that the GPS coordinates of the elevated reflector can be calculated. The GPS device then communicates the coordinates via the electrical network to the computer communicatively associated with the imaging device. In the preferred embodiment the signal containing position information is wirelessly transmitted; however, alternate transmission methods are also contemplated. One such alternative is by means of a tethered cable running between the elevated reflector and the computer associated with the imaging device.

In the preferred embodiment, a curved reflector is utilized and thus the reflection of the target area will appear distorted. A means for deconvolving images 12 implemented on computer 14 communicatively associated with the imaging device is necessary to create an undistorted image of the target. The distortion is dependent on three main parameters: the shape of the reflector, the location of the airborne reflector, and the location of the ground station. With pre-existing knowledge of the shape of the reflector, those skilled in the art can create an algorithm to deconvolve the reflected target image according to the current position of the reflector relative to the ground based station. Methods utilizing such algorithms are widely known in the field of image processing and will be readily ascertainable to one of ordinary skill in the art. If the elevated reflector is flat, no such deconvolving means are necessary.

In the preferred embodiment, the air flight means 6 is depicted as a dirigible. However, other air flight means will be recognized by a person of ordinary skill in the art. Examples not by way of limitation include: airplanes, blimps, helicopters, balloons, unmanned aerial vehicles (“UAVs”), gliders, and other recognized means for sustained flight.

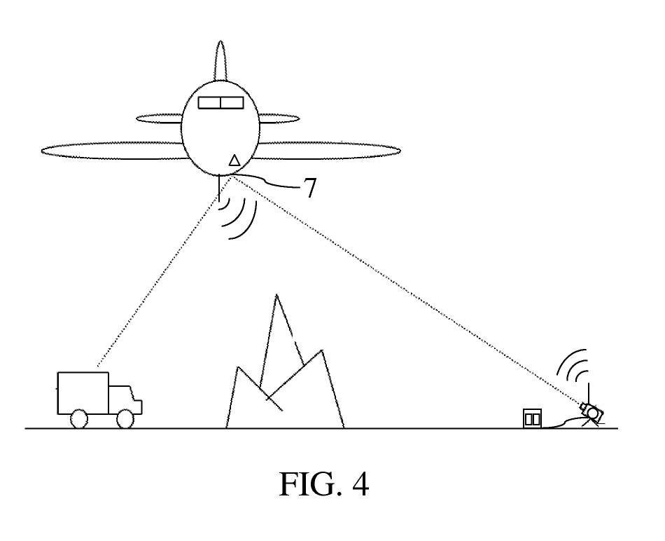

Referring now to FIG. 4, there is illustrated an alternative embodiment of the invention. In this embodiment all of the elements of FIG. 3 remain except the elevated reflector 7 is incorporated into the outer surface of an air flight means. This incorporation may be conducted by integrating a specularly reflective surface into the solid surface of an air flight means such as an airplane, or by integrating a flexible specularly reflective surface such as a boPET film into the outer surface of a lighter-than-air air flight means such as a dirigible. Other equivalent integration methods will be recognized by those of ordinary skill in the art.

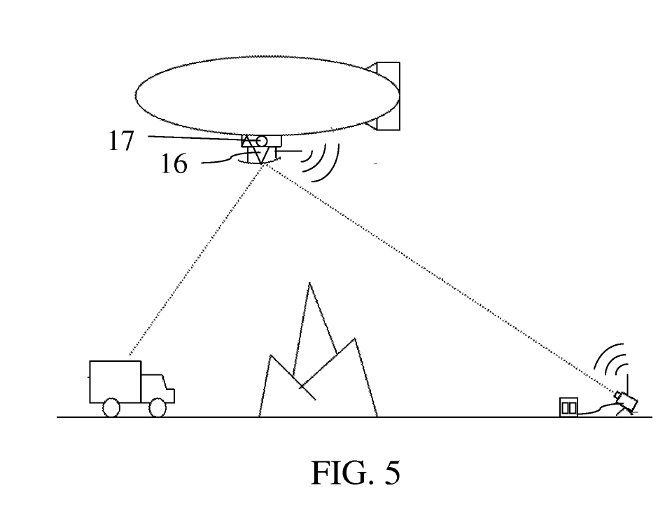

Referring now to FIG. 5, there is illustrated yet another alternative embodiment of the invention. In this embodiment all of the elements of FIG. 3 remain except that the elevated reflector is now connected to the air flight means by a flexible mount 16. The flexible mount allows the elevated reflector to turn up to 360° in the horizontal direction and 180° in the vertical direction enabling the elevated reflector to react to changes in the location of the elevated reflector relative to the imaging device. It may also take the form of a gyroscope allowing the elevated reflector to remain in a more stable position relative to the ground. The flexible mount can be operatively associated with a motorized actuator 17 that, in conjunction with the position information communicated by the electrical network and control systems implemented on the computer, will automatically adjust the elevated reflector such that the LOS of the imaging device is continuously trained on the elevated reflector. Such control systems will be readily recognized by those of ordinary skill in the art.

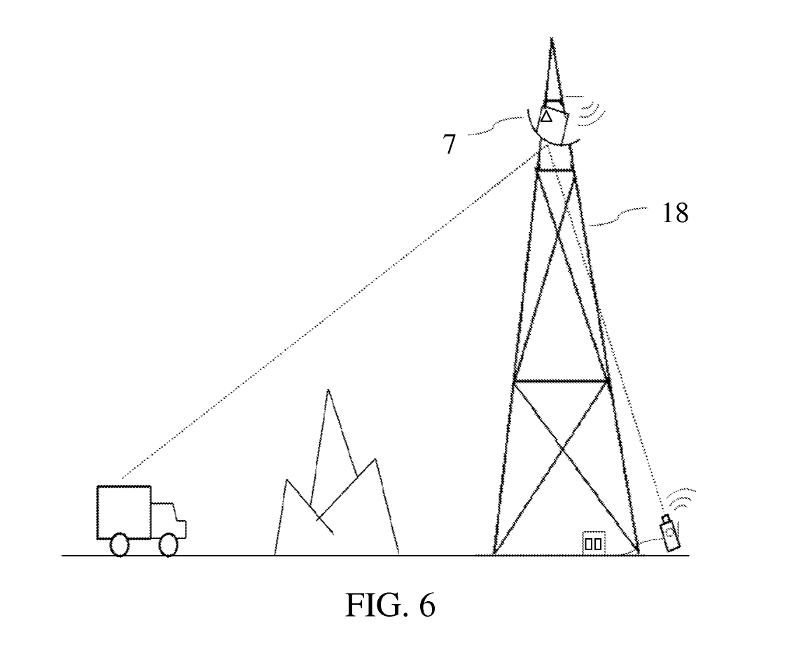

Referring now to FIG. 6, there is illustrated yet another alternative embodiment of the invention. In this embodiment all of the elements of FIG. 3 remain except that the air flight means is replaced with a tower 18. Elevated reflector 7 is connected to the high end of a tower 18, with a direct line of sight between the imaging device and the elevated reflector. The elevated reflector may be fixed or attached to a flexible mount connected to a motorized actuator such that the elevated reflector may be adjusted.

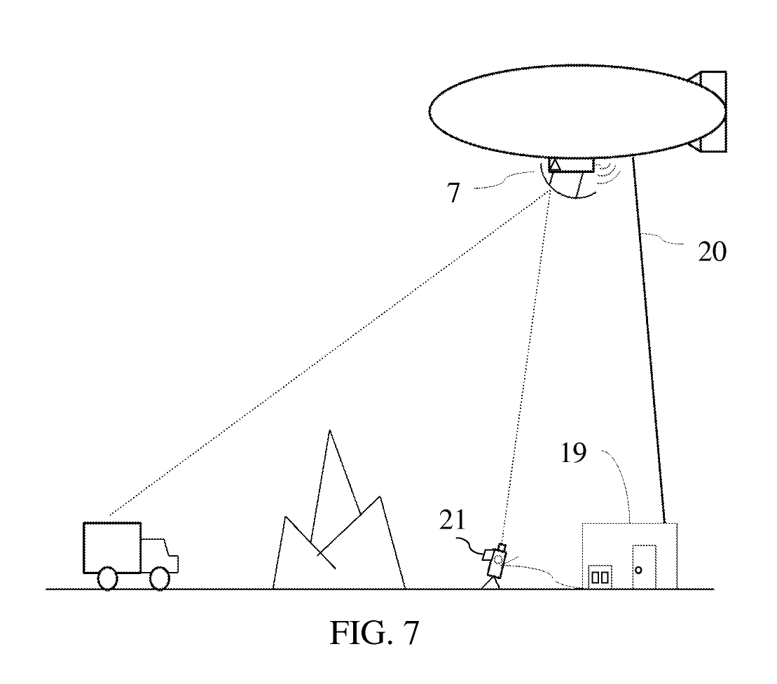

Referring now to FIG. 7, there is illustrated yet another alternative embodiment of the invention. In this embodiment all of the elements of FIG. 3 remain with the addition ground station 19 connected to the air flight means by a tether 20 and a laser range-finder or targeting device 21 attached to the imaging device. The ground station is connected to a power source such that power can be transferred through the tether to power the air flight means and any associated components such as an adjustable elevated reflector. It should be recognized that although the ground station is depicted in FIG. 7 on solid ground, it can also be configured such that it is floating on water. This could be achieved for example by placing the ground station on a barge, ship, or equivalent means for flotation. In this embodiment, the elevated reflector 7 would have a relatively fixed location and the imaging device would focus on a small section of the elevated reflector. By focusing on various areas of the reflector, the imaging device would have an effective field of view of 360°, extending to the horizon. Farther out from the ground station, the reflected view would have higher distortion and less focus, depending on the exact shape and manufactured precision of the reflector, as well as the resolution and range of the imager. It should be noted that any of the embodiments herein disclosed allow for the imaging device to focus on a small section of the elevated reflector to achieve greater resolution of an image captured on a particular portion of the elevated reflector.

As an alternative to the embodiment described in FIG. 7 the tether could be removed and instead the ground station 19 would direct the air flight means (which may be piloted or an UAV) to a designated spot. Ideally, the aircraft would transmit its location to the ground station via any number of existing communication methods, including but not limited to encrypted radio and satellite systems. If communication is lost, the ground station imager itself could track the position of the reflector through visual contact. Image stabilization would also be implemented to compensate for deviations in the reflector positioning.

In addition, it should be recognized that even without knowing the exact position and orientation of the elevated reflector, the reflected image combined with existing general knowledge of the surveillance area would still yield useful information. For example, very few people know the angle that their rear-view minor is set at in their automobile. However, by referencing where the other vehicles are in relation to the reflections of the rear window, back seats, etc, they can figure out where other vehicles are in relation to their own. Similarly, if the reflected image shows a recognizable location such as a road or mountain pass, then the ground station can confirm the area under surveillance without knowing the position of the airborne reflector.

Lastly, an alternate use of the invention is in the area of laser targeting and range-finding (for use with laser-guided weapons). Traditional laser targeting relies on an operator with a direct LOS to the target. This puts the operator in potential harm's way, as they may be detectable by the target. Using the airborne reflector, the operator could remain hidden behind a barrier (natural or manmade) and indirectly paint the target with the laser by aiming the laser range-finding or targeting device 21 at the reflection of the target. Such a device could be hand-held or attached to the imaging device. Knowing the position of the reflector would also allow the operator to use similar methods to indirectly acquire the range to the target or to utilize indirect laser-scanning to perform terrain mapping. Similarly, the laser range-finder allows for another method for tracking the position of the elevated reflector. In this method a laser range-finder directs a beam at the elevated reflector, and it is determined at what angle relative to the horizontal the reflected beam reaches maximum intensity. Using this angle, the known position of the laser range-finder, and the distance to the elevated reflector measured by the laser range-finder, one of ordinary skill in the art can employ well-known geometrical relationships to determine the position of the elevated reflector to a high precision.

1. An imaging system, comprising:
An imaging device; and
At least one elevated reflector.

2. The imaging system of claim 1, further comprising an electrical network connecting said imaging device and said elevated reflector.

3. The imaging system of claim 2, wherein said imaging device is connected to a flexible mount.

4. The imaging system of claim 3, wherein said flexible mount is connected to a motorized actuator.

5. The imaging system of claim 1, further comprising a means for deconvolving images implemented on a computer communicatively associated with said imaging device.

6. The imaging system of claim 1, further comprising a means for deconvolving images implemented on said imaging device.

7. The imaging system of claim 1, wherein said imaging device is operatively connected to a high-powered, zoom lens.

8. The imaging system of claim 1, wherein said at least one elevated reflector is connected to a means for air flight.

9. The imaging system of claim 8, wherein said at least one elevated reflector is integrated into the surface of said air flight means.

10. The imaging system of claim 8, wherein said at least one elevated reflector is connected to said air flight means by a flexible mount.

11. The imaging system of claim 10, wherein said at least one elevated reflector is stabilized by a mechanism incorporating a gyroscope.

12. The imaging system of claim 10, wherein said flexible mount is connected to a motorized actuator.

13. The imaging system of claim 1, wherein said at least one elevated reflector is connected to the high end of a tower.

14. The imaging system of claim 1, further comprising a ground station and a means for air flight.

15. The imaging system of claim 15, wherein said ground station is connected to said air flight means by a tether.

16. (canceled)

17. The imaging system of claim 1, further comprising a laser targeting device.

18. The imaging system of claim 1, further comprising a laser range-finding device.

19. An imaging system, comprising:
An imaging device;
A means for air flight;
At least one elevated reflector connected to said air flight means;
A computer communicatively associated with said imaging device;
A means for deconvolving images implemented on said computer; and
An electrical network connecting said imaging device, said air flight means, said at least one elevated reflector, and said computer.

20. An imaging system, comprising:
An imaging device connected to a flexible mount and motorized actuator;
A means for air flight;
At least one elevated reflector connected to said air flight means;
A computer communicatively associated with said imaging device;
A means for deconvolving images implemented on said computer;
A means for position identification of said at least one elevated reflector;
A means for controlling the position of said imaging device implemented on said computer; and
An electrical network connecting said imaging device, said air flight means, said at least one elevated reflector, said computer, and said position identification means.
